(19) United States
(12) Patent Application Publication
(10) Pub. No.: US 2014/0325335 A1
(43) Pub. Date: Oct. 30, 2014

(54) SYSTEM FOR GENERATING MEANINGFUL TOPIC LABELS AND IMPROVING AUTOMATIC TOPIC SEGMENTATION

(71) Applicant: CISCO TECHNOLOGY, INC., San Jose, CA (US)

(72) Inventors: Matthias Paulik, San Jose, CA (US); Sachin S. Karajekar, Sunnyvale, CA (US); Venkata Ramana Rao Gadde, Santa Clara, CA (US); Qian Diao, San Jose, CA (US)

(73) Assignee: Cisco Technology, Inc., San Jose, CA (US)

(21) Appl. No.: 13/870,467

(22) Filed: Apr. 25, 2013

(51) Int. Cl. G06F 17/22

(52) U.S. Cl. CPC G06F 17/2247
USPC 715/234

(57) ABSTRACT

In one embodiment, a method includes obtaining a text representation, and identifying a current topic structure for the text representation. The first topic structure is initially identified as an initial first topic structure. The method also includes identifying at least a first document that has a first document topic structure that is similar to the current first topic structure, refining the current first topic structure based on the first document topic structure, and introducing topic labels in the text representation based on the current first topic structure.

### TECHNICAL FIELD

The disclosure relates generally to managing video and/or audio content. More particularly, the disclosure relates to efficiently and effectively generating meaningful topic labels for video and/or audio content, and for improving automatic topic segmentation for video and/or audio content.

### BACKGROUND

Video and/or audio interactions, e.g., telephone calls or multi-media conference sessions, are often recorded and converted into text representations. Topic segmentation systems generally discover the underlying topic structure that may be present in a text representation, e.g., transcript of video and/or audio. Such topic segmentation systems identify coherent topic segments, typically by studying the distribution of topic-specific words and phrases encountered in a text representation. However, attaching meaningful labels to automatically identified topic segments is difficult.

Manual topic labels are one solution to attaching meaningful labels to topic segments, i.e., manually inserting topic labels may be one method of accurately attaching meaningful labels to topic segments, While manually attaching topic labels is generally effective, it is often time-consuming for an individual to provide topic labels.

Another solution to attaching meaningful labels to automatically identified topic segments involves automatically labeling a topic segment using the most frequently used phrase or phrases within the topic segment. This approach often results in inaccurate topic labels that may carry no substantial meaning with respect to the actual topics associated with the sections.

### BRIEF DESCRIPTION OF THE DRAWINGS

The disclosure will be readily understood by the following detailed description in conjunction with the accompanying drawings in which:

FIG. 1 is a diagrammatic representation of a system in which automatic topic segmentation may be applied to a text representation of video and/or audio content and meaningful topic labels may be generated in accordance with an embodiment.

FIG. 2 is a process flow diagram that illustrates one method of generating meaningful topic labels for a text representation of video and/or audio in accordance with an embodiment.

FIG. 3 is a block diagram representation of a device, e.g., device 132 of FIG. 1, suitable for generating meaningful topic labels for a text representation of video and/or audio in accordance with an embodiment.

FIG. 4 is a diagrammatic representation of a text representation with topic labels that are generated using topic labels associated with documents stored in a document store in accordance with an embodiment.

### DESCRIPTION OF EXAMPLE EMBODIMENTS

### General Overview

According to one aspect, a method includes obtaining a text representation, and identifying a current topic structure for the text representation. The first topic structure is initially identified as an initial first topic structure. The method also includes identifying at least a first document that has a first document topic structure that is similar to the current first topic structure, refining the current first topic structure based on the first document topic structure, and introducing topic labels in the text representation based on the current first topic structure.

### Description

The ability to automatically segment a text representation of video and/or audio content into topics, and to automatically generate meaningful topic labels, allows the text representation of the video and/or audio content to be accurately segmented into topics such that the topics are accurately labeled. As a result, anyone viewing the text representation may readily identify the topics within the text representation. In addition, when the text representation is included in a document store, a search of a document store for documents of a particular topic that will generally discover the text representation if the text representation has a topic label that corresponds to the particular topic.

By initially identifying a topic structure in a text representation of video and/or audio content, and then discovering written documents that are similar in content and structure to the text representation, the written documents may be used to refine the topic structure identified in the text representation and to generate meaningful topic labels for the various topics identified in the text representation. As new written documents may be added to document stores substantially continuously, written documents may be continuously or periodically harvested from the documents stores and used to refine the topic structure identified in a text representation. An initial topic structure identified within a text representation may be refined iteratively and, thus, improved. Further, proposed topic labels for topics contained in a text representation may be refined.

In a corporate setting, meetings may involve the discussion of one or more structured document, e.g., slide presentations and/or a software specification documents. Many meetings that involve the discussion of structured documents are recorded. By searching or crawling a document server on which structured documents are stored, documents discussed during, and/or created as a result of, a recorded meeting, may be identified. When documents which were discussed and/or created during a recorded meeting are discovered during a search or a crawl of a document server, and are used to perform topic segmentation and topic labeling of a text representation of the recorded meeting, the topic segmentation and topic labeling of the text representation may have a high level of accuracy.

By comparing sections within a document to sections within a text representation of video and/or audio content, the accuracy with which topic labels are identified for the sections within the text representation may be enhanced. In other words, exploiting section headings within a document in order to generate topic labels for a text representation of video and/or audio content allows more meaningful, e.g., substantially exact or accurate, topic labels to be generated.

In one embodiment, after obtaining a text representation of video and/or audio content, relevant written documents are identified, and the titles, sections headings, and figure captions are effectively exploited for purposes of topic labeling within the text representation. Titles, section headings, and figure captions in written documents may be identified by analyzing the structure of the written documents. When the content and the structure of a written document is similar to that of a text representation of video and/or audio content, then the titles, section headings, and figure captions of the written document may be used, in addition to the structure of the written document, to refine topic labels and the structure of the text representation. In general, section headings of sections of written documents that match topics in a text representation of video and/or audio content may be used to derive topic labels for the text representation.

A topic structure, e.g., a topic segmentation or topic sequence, generally relates to content and document structure. Hence, if a written document and a text representation of video and/or audio content have a similar topic structure, the written document and the text representation will generally have substantially the same content and substantially the same document structure. As used herein, a document structure generally refers to structural elements of a document. Thus, if a written document and a text representation of video and/or audio content have similar document structures, then the written document and the text representation may generally have the same structural elements. Structural elements of a document may include, but are not limited to including, titles, headings, figure captions, sections, chapters, paragraphs, and/or sentences.

In one embodiment, titles, headings, and figure captions may be leveraged as topic label candidates. A document structure may be leveraged to refine a topic structure. For instance, a document structure may effectively provide an initial potential topic structure for a document, e.g., a written document. An initial potential topic structure may effectively use titles, headings, figure captions, sections, chapters, paragraphs, and/or sentences as initial topics. There may be a certain number, e.g., a number “N”, of initial potential topic segmentations in a written document that may be compared to a certain number, e.g., a number “M”, of topic segmentations that have been automatically identified in a text representation.

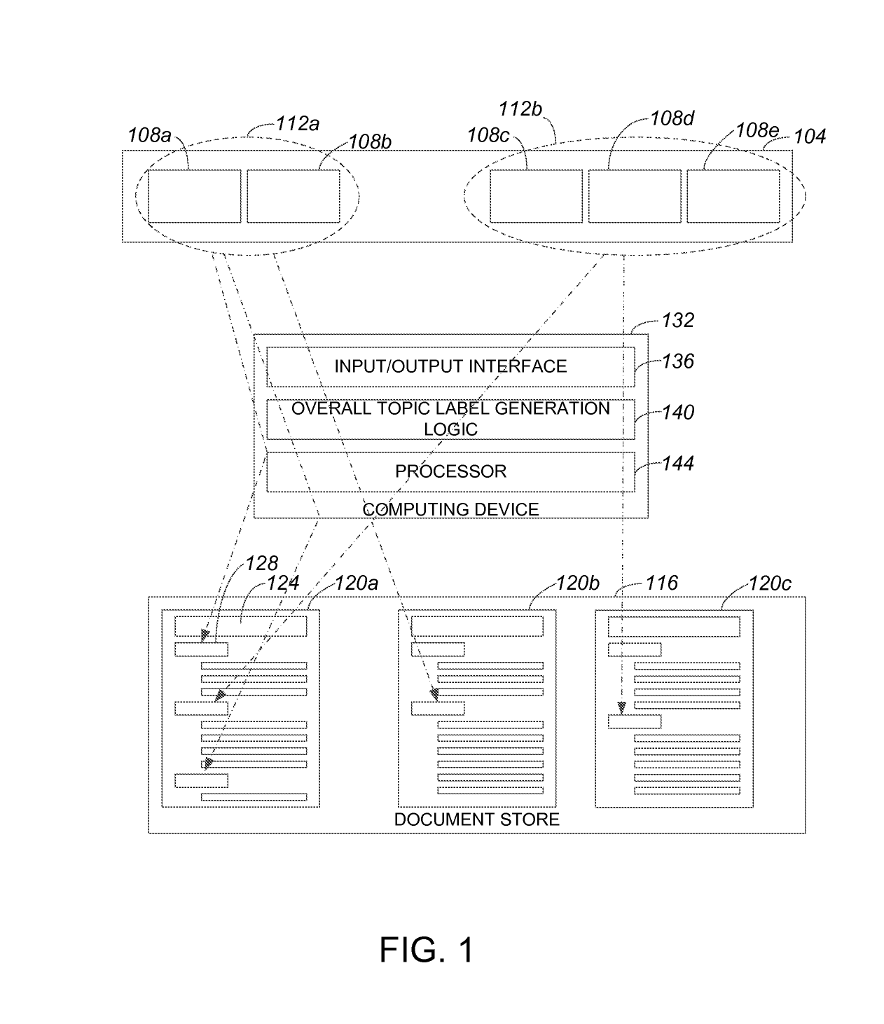

Referring initially to FIG. 1, a system in which automatic topic segmentation may be applied to a text representation of video and/or audio content and meaningful topic labels may be generated will be described in accordance with an embodiment. Video and/or audio content 104 includes spoken words 108a-e, which may generally form spoken phrases. Spoken words 108a-e, or spoken phrases, may generally be processed by a computing device or element 132 to identify different topics 112a, 112b associated with spoken words 108a-e, and to effectively segment spoken words 108a-e into groups based on topics 112a, 112b. That is, computing device 132 generally identifies a topic structure associated with video and/or audio content 104. As shown, spoken words 108a, 108b are associated with topic 112a, and spoken words 108c-e are associated with topic 112b.

Computing device 132 accesses documents 120a-c contained in a document store 116 to refine an initial topic structure associated with video and/or audio content 104, and to determine or otherwise identify potentially suitable topic labels for topics 112a, 112b. For example, computing device 132 may access document 120a to determine whether the content of document 120a, including a title 124 and/or a section heading 128, has a structure that is similar to that of video and/or audio content 104. It should be appreciated that documents 120a-c within document store 116 are generally compared to a text representation (not shown) of video and/or audio content 104.

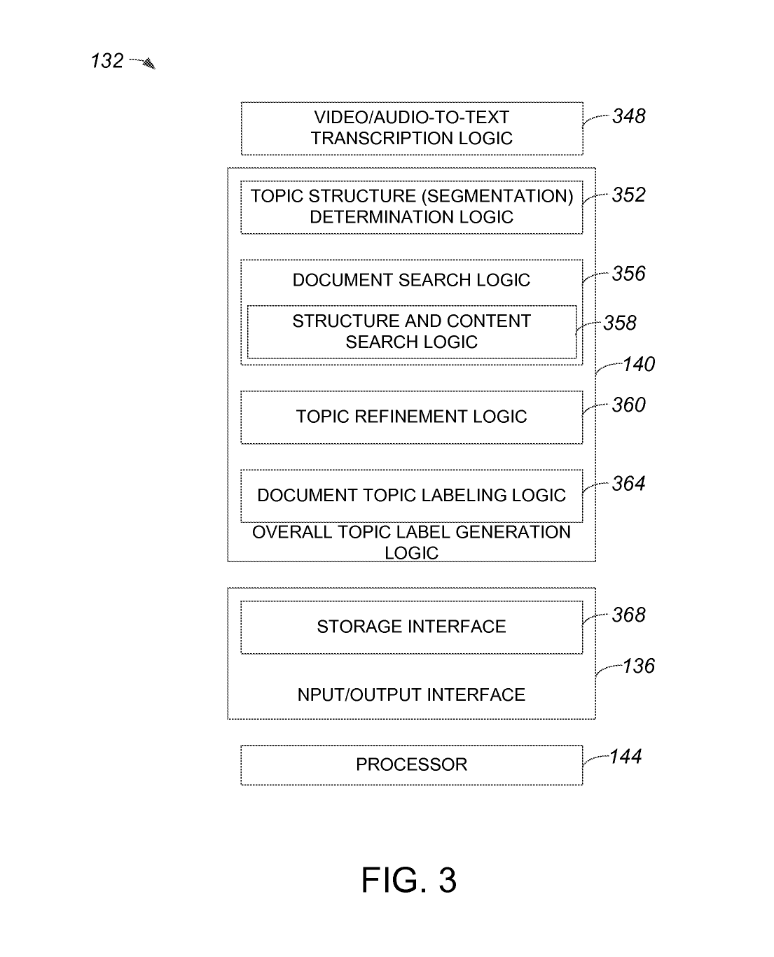

Computing device 132, which will be discussed in more detail below with respect to FIG. 3, includes a processor 144, overall topic label generation logic 140, and an input/output (I/O) interface 136. Overall topic label generation logic 140 is configured to iteratively refine a topic structure and topic labels associated with video and/or audio content 104 by crawling document store 116 and analyzing documents 120a-c stored within document store 116. I/O interface 136 is arranged to obtain information relating to video and/or audio content 104, and to allow computing device 132 to access document store 116.

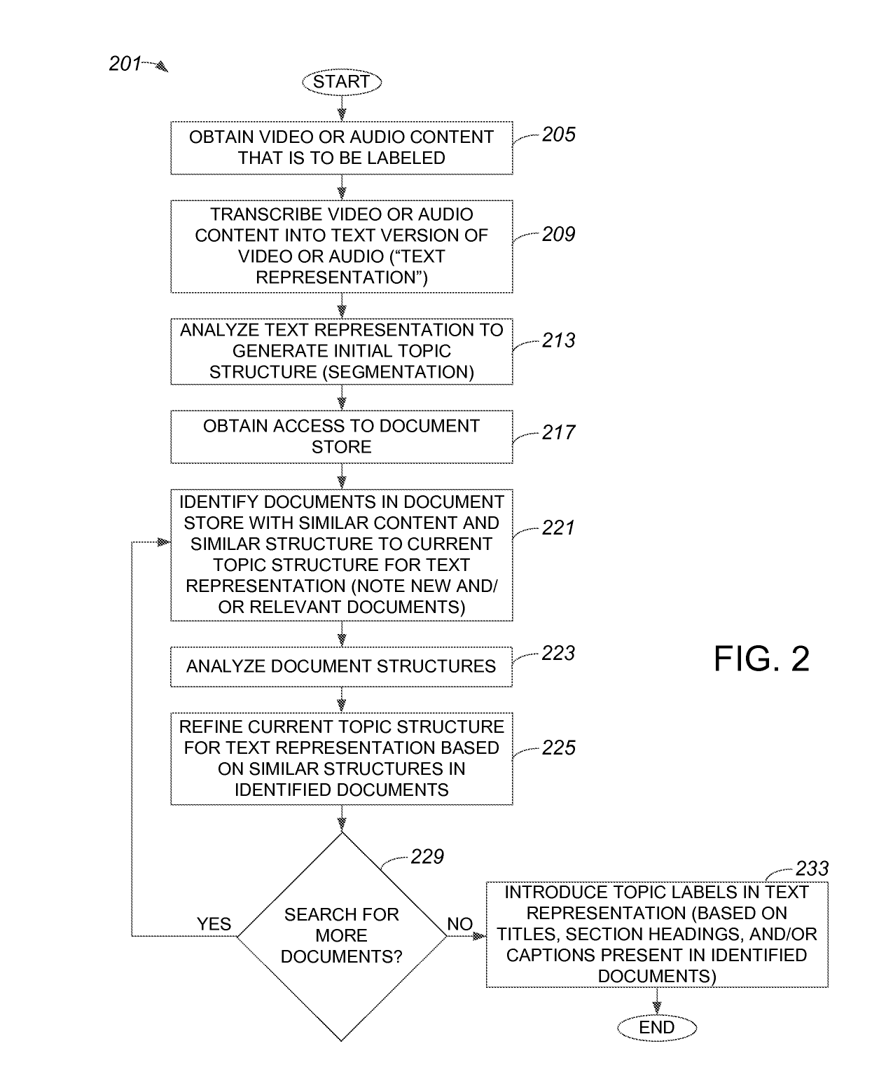

FIG. 2 is a process flow diagram which illustrates one method of generating meaningful topic labels for a text representation of video and/or audio in accordance with an embodiment. A method 201 of generating meaningful topic labels for a text representation or transcript begins at step 205 in which video and/or audio content to be labeled is obtained. The video and/or audio may be obtained from any suitable source, e.g., from a multi-media conference application.

Once video or audio content that is to be labeled is obtained, the video and/or audio content that is to be labeled is transcribed in step 209 into a text representation. That is, a text version or a transcript of video and/or audio content is created. In general, any suitable video-to-text or audio-to-text transformation application may be used to create a text representation of video content or audio content, respectively.

In step 213, the text representation obtained in step 209 is analyzed, and an initial topic structure is generated. The initial topic structure, or initial topic segmentation, may be created using any suitable generative, e.g., supervised, or unsupervised approach. Suitable approaches may include, but are not limited to including a Bayesian approach to topic segmentation or a Hidden Markov Model based approach to topic segmentation. It should be appreciated that the number of segmentations generated for an initial topic structure may vary. In one embodiment, a predetermined number of segmentations may be specified such that the initial topic structure includes the predetermined number of segmentations.

After the initial topic structure is generated, access to a document store is obtained in step 217. A document store may generally be any suitable database, repository, or document server which contains documents that include, but are not limited to including, titles, section headings, and/or captions associated with figures. By way of example, a document server may be a server associated with an enterprise that contains multiple documents owned by the enterprise. The documents stored in a document store generally include written documents, as well as documents which are effectively text versions of other video and/or audio content.

Documents in the document store which have similar content and a similar structure to the current, e.g., initial, topic structure associated with the text representation are identified in step 221. In general, documents in the document store which have a similar structure and content as the text representation may be substantially automatically identified by crawling the document store. After documents which have a similar structure to the current, e.g., initial, topic structure associated with the text representation are identified, document structures associated with the identified documents may be analyzed in step 223. Analyzing the document structures may include, but is not limited to including, building a statistical model based on the document structures and analyzing statistics associated with the document structures. For example, the length and order of document sections, n-gram distributions within and across sections, and/or cue phrases at the beginning or end of sections, may be analyzed.

The topic structure for the text representation may be refined in step 225 based on information obtained as a result of analyzing the document structures. That is, an updated topic structure for the text representation may effectively be generated in step 225. After the topic structure for the text representation is refined, a determination is made in step 229 as to whether the document store is to be searched for more documents. A determination of whether to search for more documents may include determining whether there has been convergence, e.g., when the current topic structure does not differ significantly from a previous topic structure, and/or whether a previous crawl of the document store yielded any new relevant documents. For example, if there has been convergence and/or no new relevant documents have been found, then the determination may be not to search for more documents.

If the determination in step 229 is not to search for more documents, then the topic labels associated with the topic structure for the text representation which were identified in step 225 are derived and introduced as topic labels in the text representation in step 233. The topic labels may be introduced based on titles, section headings, and/or captions present in the documents that were identified. Once topic labels are introduced, the method of generating meaningful topic labels is completed.

Alternatively, if the determination in step 229 is that more documents are to be searched, process flow moves from step 229 back to step 221 in which documents in the document store with a similar structure to the current topic structure for the text representation are identified. In addition to identifying documents in the document store, any new relevant documents are noted. That is, new relevant documents which have not previously been in the document store, e.g., when a previous search or crawl of the document store was performed, are identified and effectively flagged. As will be appreciated by those in the art, a document store may be such that new documents are added to document store at substantially any time. Thus, a new crawl of a document store may generally identify new documents which were not identified during a previous crawl of the document store.

A device that generates meaningful, or accurate, topic labels may generally be a computing device. FIG. 3 is a block diagram representation of a device, e.g., device 132 of FIG. 1, suitable for generating meaningful topic labels for a text representation of video and/or audio in accordance with an embodiment. Device 132 generally includes processor 144, I/O interface 136, and overall topic label generation logic 140, as discussed above with respect to FIG. 1. As shown, I/O interface 136 includes a storage interface 368 which is arranged to access a document store (not shown) which contains documents that may be searched during the course of generating topic labels. Such a document store (not shown) may be a part of device 132, or may be external to device 132 and accessible to device 132 through a network (not shown). Device 132 also includes video/audio-to-text transcription logic 348 that is configured to convert video and/or audio content into a text representation.

Overall topic label generation logic 140 includes topic structure, or segmentation, determination logic 352 that is configured to identify a topic structure in a text representation, e.g., a text representation generated by video/audio-to-text transcription logic 348. Topic structure determination logic 352 generally identifies topics in the text representation, and effectively segments or divides text representation into different sections based, for example, on the topics.

Document search logic 356, which is also included in overall topic label generation logic 140, is configured to search for documents that have a similar structure to a topic structure for a text representation that is identified by topic structure determination logic 352. Document search logic 356 includes structure and content search logic 358 which is configured to search a set of documents to identify documents with similar structure and/or similar content as a text representation.

Topic refinement logic 360 is configured to analyze documents which are identified as having a similar structure and/or similar content as a text representation, and to adjust or update the topic structure in the text representation as needed. For example, the topic structure of a text representation may be refined to more accurately identify the topics in different sections of the text representation using statistics obtained by analyzing documents identified as having a similar structure and/or similar content. Topic refinement logic 360 may be arranged to continue to refine the topic structure of a text representation, e.g., to iteratively refine the topic structure of a text representation, until such time as it is determined that the topic structure of the text representation is effectively accurately identified. In other words, when there is convergence in the topic structure and/or no new documents are obtained during a document search, topic refinement logic 360 may determine that benefit derived from continuing to refine the topic structure of the text representation is relatively insignificant.

Overall topic label generation logic 140 also includes document topic labeling logic 364. Document topic labeling logic 364 is arranged to insert topic labels, e.g., titles and/or section headings, into the text representation to effectively create a new document. Such a new document, or augmented text representation, may be stored in a document store (not shown).

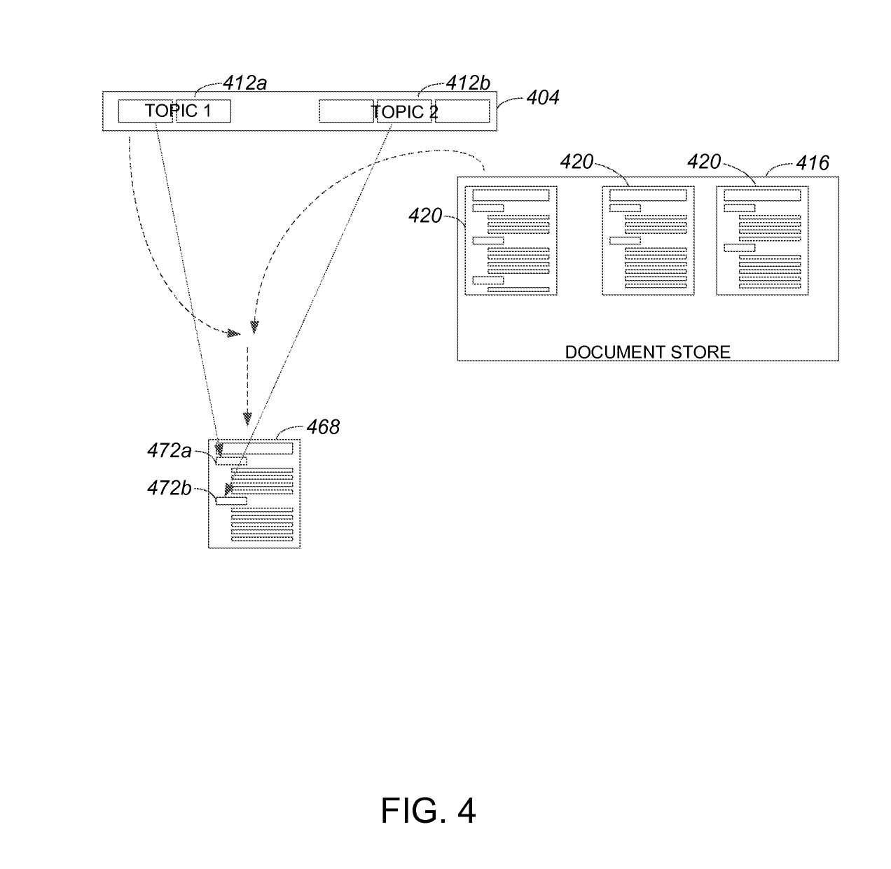

With reference to FIG. 4, a text representation of video and/or audio content with topic labels that are generated using topic labels associated with documents stored in a document store will be described in accordance with an embodiment. Data 440 that is associated with video and/or audio content includes a first set of information 412a associated with a first topic and a second set of information 412b associated with a second topic. Topic labels associated with documents 420 in a document store 416 are compared to information 412a, 412b to generate a new document 468 that is generally a text representation of data 404, and includes topic labels 472a, 472b. As shown, topic label 472a corresponds to first set of information 412a, and topic label 472b corresponds to second set of information 412b.

Although only a few embodiments have been described in this disclosure, it should be understood that the disclosure may be embodied in many other specific forms without departing from the spirit or the scope of the present disclosure. By way of example, instead of automatically inserting meaningful topic labels into a text representation of audio and/or visual content, suggested meaningful topic labels may instead to be provided to a user such that the user may determine whether he or she wishes to insert the suggested meaningful topic labels into the text representation. That is, topic labels may be generated and then effectively manually inserted into a text representation. In one embodiment, for each topic identified through topic segmentation within a text representation, more than one suggested topic label may be provided such that a user may select the most accurate topic label for use in labeling a topic.

Written documents which are searched to identify documents which have a similar topic structure to the topic structure of a text representation of visual and/or audio content may include any suitable written documents. For instance, written documents may include web pages, emails, chat transcripts, and substantially any suitable structured written document.

While a text representation has generally been described as being a text version of a video and/or audio recording, it should be appreciated that a text representation is not limited to being a text version of a video and/or audio recording. By way of example, a text representation may be a text version of a live conference, or a text representation may be a transcript of a live chat session without departing from the spirit or the scope of the present disclosure.

In general, video and/or audio content has been described as including spoken words, e.g., spoken words which form spoken phrases, that are processed to identify topics. It should be appreciated that content that is processed to identify topics is not limited to including spoken words. For instance, video content may include written words that may be processed to identify topics. Further, video content may include words which may be identified by effectively reading the lips of individuals who are portrayed in the video content.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. For example, in lieu of obtaining video and/or audio content and transcribing the video and/or audio content into a text representation during a process of generating meaningful topic labels, a text representation such as a document may be obtained. That is, the methods of the present disclosure may generally be applied to documents, and are not limited to being applied to text representations of video and/or audio content. Therefore, the present examples are to be considered as illustrative and not restrictive, and the examples are not to be limited to the details given herein, but may be modified within the scope of the appended claims.

What is claimed is:

1. A method comprising:
obtaining a text representation;
identifying a current topic structure for the text representation, the first topic structure being initially identified as an initial first topic structure;
identifying at least a first document that has a first document topic structure that is similar to the current first topic structure;
refining the current first topic structure based on the first document topic structure; and
introducing topic labels in the text representation based on the current first topic structure.

2. The method of claim 1 wherein the text representation is a text version of at least one selected from a group including audio content and video content, and wherein introducing the topic labels in the text representation includes identifying the topic levels using the current first topic structure and associating the topic labels with the text representation.

3. The method of claim 2 wherein the text representation is obtained by transcribing the at least one selected from the group including audio content and video content.

4. The method of claim 1 further including:
accessing a document store, wherein identifying the at least first document that has the first document topic structure that is similar to the current first topic structure includes searching the document store to identify the at least first document that has the first document topic structure that is similar to the current first topic structure.

5. The method of claim 4 further including:
determining when to search the document store for at least a second document after refining the current first topic structure, wherein the at least second document has a second document topic structure that is similar to the current first topic structure;
identifying the at least second document that has the second document topic structure that is similar to the current first topic structure when it is determined that the document store is to be searched for the at least second document; and
refining the current first topic structure based on the second document topic structure.

6. The method of claim 5 wherein the topic labels are introduced in the text representation based on the current first topic structure when it is determined that the document store is not to be searched for the at least second document.

7. The method of claim 1 wherein identifying the at least first document that has the first document topic structure that is similar to the current first topic structure includes identifying at least one selected from a group including sections headings in the at least first document and figure captions in the at least first document.

8. A tangible, non-transitory computer-readable medium comprising computer program code, the computer program code, when executed, configured to:
obtain a text representation;
identify a current topic structure for the text representation, the first topic structure being initially identified as an initial first topic structure;
identify at least a first document that has a first document topic structure that is similar to the current first topic structure;
refine the current first topic structure based on the first document topic structure; and
introduce topic labels in the text representation based on the current first topic structure.

9. The tangible, non-transitory computer-readable medium comprising computer program code of claim 8 wherein the text representation is a text version of at least one selected from a group including audio content and video content, and wherein the computer program code configured to introduce the topic labels in the text representation is further configured to identify the topic levels using the current first topic structure and to associate the topic labels with the text representation.

10. The tangible, non-transitory computer-readable medium comprising computer program code of claim 9 wherein the text representation is obtained using computer program code configured to transcribe the at least one selected from the group including audio content and video content.

11. The tangible, non-transitory computer-readable medium comprising computer program code of claim 8 further comprising computer code configured to:
access a document store, wherein the computer code configured to identify the at least first document that has the first document topic structure that is similar to the current first topic structure is configured to search the document store to identify the at least first document that has the first document topic structure that is similar to the current first topic structure.

12. The tangible, non-transitory computer-readable medium comprising computer program code of claim 11 further comprising computer code configured to:
determine when to search the document store for at least a second document after the current first topic structure is refined, wherein the at least second document has a second document topic structure that is similar to the current first topic structure;
identify the at least second document that has the second document topic structure that is similar to the current first topic structure when it is determined that the document store is to be searched for the at least second document; and
refine the current first topic structure based on the second document topic structure.

13. The tangible, non-transitory computer-readable medium comprising computer program code of claim 12 wherein the topic labels are introduced in the text representation based on the current first topic structure when it is determined that the document store is not to be searched for the at least second document.

14. The tangible, non-transitory computer-readable medium comprising computer program code of claim 8 wherein the computer program code configured to identify the at least first document that has the first document topic structure that is similar to the current first topic structure is configured to identify at least one selected from a group including sections headings in the at least first document and figure captions in the at least first document.

15. An apparatus comprising:
means for obtaining a text representation;
means for identifying a current topic structure for the text representation, the first topic structure being initially identified as an initial first topic structure;
means for identifying at least a first document that has a first document topic structure that is similar to the current first topic structure;
means for refining the current first topic structure based on the first document topic structure; and
means for introducing topic labels in the text representation based on the current first topic structure.

16. An apparatus comprising:
a processor;
an interface, the interface being arranged to obtain content; and
logic arranged to be executed by the processor, the logic including topic structure determination logic arranged to initially identify a topic structure associated with the content and to refine the topic structure associated with the content based on at least one document topic structure identified by processing a plurality of documents, the at least one document topic structure being similar to the topic structure associated with the content, wherein the logic further includes labeling logic arranged to provide topic labels associated with the content, the topic labels being associated with the topic structure.

17. The apparatus of claim 16 wherein the content is one selected from a group including video content and audio content, and wherein the logic further includes transcription logic configured to generate a text representation from the content.

18. The apparatus of claim 17 wherein the topic structure associated with the content is determined by segmenting the text representation, and wherein the labeling logic arranged to provide the topic labels associated with the content is further arranged to provide the topic labels in the text representation.

19. The apparatus of claim 16 wherein the structure determination logic arranged to refine the topic structure associated with the content based on at least one document topic structure identified by processing a plurality of documents is arranged to iteratively refine the topic structure.

20. The apparatus of claim 16 further including:
a document store, the plurality of documents being stored in the document store, wherein processing the plurality of documents includes accessing the plurality of documents and identifying section headings contained in the plurality of documents.
